(19) United States
(12) Patent Application Publication
(10) Pub. No.: US 2019/0392689 A1
(43) Pub. Date: Dec. 26, 2019

(54) MODULE FOR PASSIVE SURFACE MONITORING

(71) Applicants: Philipp Fischer, Eibelstadt (DE); Christoph Schwarz, Sommerhausen (DE)

(72) Inventor: Karl-Alfred Schwarz, Ochsenfurt (DE)

(21) Appl. No.: 16/464,232

(22) PCT Filed: Nov. 23, 2017
(86) PCT No.: PCT/DE2017/101017

§ 371 Date: May 24, 2019

(30) Foreign Application Priority Data
Nov. 28, 2016 (DE) 102016122923.7

(51) Int. Cl. G08B 13/12; G08B 21/18; G01V 3/02; G01V 3/08

(52) U.S. Cl. CPC G08B 13/126; G01V 3/08; G01V 3/02; G08B 21/182

(57) ABSTRACT

Module for the passive monitoring of areas for penetration in cooperation with an alarm system (A), comprising:
A non-conducting, mechanically stable substrate layer (2) and
at least two conducting regions (3), which are superimposed on the substrate layer (2) and are connected to it, and the extent of which is significantly smaller in at least one spatial direction than in the other, at least two of the conducting regions (3) having contacts (31), by means of which they can be contacted via wires (19) and in particular can be connected to the alarm system (A) Also a method for manufacturing a module from blanks, comprising a substrate layer with conducting material superimposed on one or both sides, by selective removal of the conducting material, in particular by means of etching or milling, such that the desired conducting regions with contact points are formed therefrom.

The present invention relates to a module for passive monitoring of surfaces for penetration as well as a method for the production and the use thereof.

In the case of safety-related rooms or regions, it is often necessary to monitor the entire interior surface such that no unauthorized penetration occurs. Regions to be monitored in this manner concern general areas in which valuable and/or dangerous objects are present, such as, for example, in the public sphere, exhibition rooms in museums, bank safes, high-security laboratories, storage areas and other rooms in nuclear power stations, nuclear arms stores, or else, in the private area, private safes or switch cabinets. Beyond these premises, which are traditionally to be monitored, the increased terrorism threat in recent times has led to a strong demand for monitoring of areas against penetration, since, in some countries, such as, for example, the United Kingdom, the entire public infrastructure, which could be threatened by terrorist activities, such as electrical substations, distribution boxes and the like are to be secured in this way.

For monitoring areas against penetration and/or climbing in, two classes of method are known: active and passive area monitoring. In the case of area monitoring, the area to be monitored is observed or scanned by means of an optical or infrared camera or a laser. When a camera is used, it is directed onto the area and a change of the area is ascertained by means of automatic image evaluation. With the use of lasers, on the other hand, from one or more laser sources, a beam more or less parallel to the surface, deflected via one or more mirrors, is guided to a detector. Interruptions or a reduction of the received beam intensity are in this case identified as a disturbance that can be equated with a penetration of the area.

The advantage of active area monitoring, on one hand, is that, particularly when a camera is used, it can provide more information than only the pure penetration of the surface itself, for example an assessment of the camera images in real time by human monitoring personnel is possible and, on the other hand, is that it can also be more easily and more quickly retrofitted. As a disadvantage, however, it is to be mentioned that the technology used is complex and therefore expensive and, because of the active character of the monitoring, is very energy intensive.

As an alternative to active monitoring, passive area monitoring is familiar, in which the electrical properties of a conducting structure which is superimposed on the area to be monitored is considered as an indication of a manipulation or penetration of the surface to be monitored. Resistive on one hand and capacitive monitoring on the other hand are known in the prior art. In the case of resistive monitoring, a reference resistance is measured continuously or at short intervals and in the case of a deviation upward or [downward?] a signal is triggered. The monitoring of an entire surface is hereby effected in that the supply line to this reference resistance is laid over the surface such that it completely covers it in a meandering manner or otherwise. A penetration of the surface is thus, with high probability associated with an impairment, possibly with an interruption, of the supply line to the reference resistance and thus with a clearly measurable deviation signal in the resistance measurement. For the case in which the tool used for penetration is conducting and by coincidence both supply lines to the reference resistance are affected simultaneously, a short circuit occurs, which can also be ascertained as a resistance deviation.

Another method of area monitoring is the capacitive. In this case not a reference resistance is monitored but the conducting structure that is superimposed on the surface to be monitored forms a capacitor with a particular capacitance. By monitoring this capacitance or the voltage of the charged capacitor, capacitance changes can be detected and, if of sufficient size, can be equated with a penetration of the surface to be monitored.

The advantage of capacitive measurement compared to resistance measurement is a further reduced energy demand, since in the normal operating condition, with the exception of small, unavoidable leakage current, no current flows. However, the disadvantage is a low accuracy and thus reliability as regards the display of a penetration. Penetrations that are small in terms of area may therein lead not to a measurably capacitance change, in particular when a non-conducting tool is used and thus a short circuit between the two capacitor poles is avoided.

For realizing a resistance-measurement-based passive area monitoring, so-called alarm-wire wall coverings are known in the prior art. These are flexible, planar elements similar to conventional wall coverings, in which, however, one or two wires, which in a meandering manner, or otherwise, cover the entire surface, or else a wire mesh, are incorporated. At the end of the wires or in the presence of only one wire on the pole of the wire and a return conductor, the reference resistance is connected, the other ends of the wire or wires conversely being further led to an alarm system and connected to the corresponding input.

These alarm-wire wall coverings represent the most widely used means for passive area monitoring. Almost all well-known manufacturers of security technology offer corresponding systems, for example Honeywell, Bosch or 3M. The advantage of such wall coverings is that they are relatively inexpensive to manufacture are can be used flexibly. However, this contrasts with the disadvantages that laying them, particularly in the case of small or poorly accessible rooms, can be very time consuming and expensive and many working hours by qualified specialists are necessary, which more than relativizes the fairly inexpensive manufacture. In addition, since, like conventional wall coverings, they are laid in rectangular strips, they are usually only poorly adaptable to other geometries as rooms comprising flat, rectangular delimiting surfaces. Surfaces that are curved in several directions, or other geometries departing from a cuboidal or rectangular shape are thereby only difficult to equip.

Also known, and also approved by VdS Schadenverhütung GmbH for self-production, are so-called alarm-wire grooved panels. In these, a groove of flexible plastic is usually milled into a panel, into which an alarm-wire corresponding to the aforementioned wall coverings can be laid. That is to say, the grooves are provided such that the surface of the panel is more or less completely covered.

The advantage of this system lies in the fact that, in principle, every manufacturer or installer of security equipment can produce a passive surface monitoring as per VdS by self-manufacture of such a panel. However, the disadvantage is that the milling of the grooves and, in particular, the laying and bonding of the alarm wire is also complicated, and the manufacturing costs for such an alarm wire panel are significantly above those of industrially manufacturable alarm wall coverings. In contrast to wall coverings, the usually more dimensionally stable panels, however, are easier to install, since pasting, as with wall coverings, is not necessary. Likewise, such panels can already be produced in the particular required dimensions, so that on installation in particular premises they can be joined together seamlessly and cover the surface to be monitored. In practice, however, such an application-specific adaptation is very time consuming, and therefore expensive.

Against this background, it is the object of the present invention to provide a passive area monitoring, which can be simply and inexpensively manufactured as well as installed, specifically with the same or better reliability of the penetration warning.

This object is achieved by means of the module for passive area monitoring according to claim 1, which is preferably manufactured according to the method of claim 9 and used according to the method of claim 11.

The essential features of the module according to the invention are the dimensionally stable substrate layer consisting of electrically insulating material, on which conducting regions for resistive or capacitive monitoring of the surface of the substrate and thereby the wall or surface on which it is installed, safeguard. The conducting regions here have contact points or contacting possibility for connecting the alarm system or wires leading to the reference resistor, which are soldered, clamped, screwed, bonded or otherwise conductively connected to the contact points. However, it is also conceivable to fix the reference resistor directly to the contact points of the conducting regions.

The conducting regions thereby either form meandering conductor paths, which more or less completely cover the surface of the substrate and thereby the surface to be monitored, the distance between the conductor path and an arbitrary point of the substrate surface always being smaller or the same size as a predetermined distance, which in turn is smaller than or at most the same as penetration holes that are conventionally to be expected or detected. If, for example, climbing through the surface is mainly to be safeguarded, considerably larger distances can be chosen than when a reaching through is to be prevented or detected. The requirements on the maximum distance are even more strict if only simple boring through is to be reliably detected.

Alternatively, the conducting regions can also be designed for capacitive monitoring. Herein, it is conceivable that the conducting regions are either planar formed and disposed on opposite sides of the substrate, so that they form one or more flat capacitors. However, it is also possible that at least two conductive regions are superimposed on one side of the substrate and formed such that they are branching and engaging in one another, wherein they approach each other with the exception of a very small distance without actually coming into contact with one another. There would thus be no conducting connection between the conducting regions, however they would form a capacitor with a capacitance dependent on the total surface area and on the branching.

In order to be able still to be able to effect measurable capacitance changes, even with small penetrations, it is also conceivable to provide a larger number of conducting regions in the above-described manner on the surface to be monitored and to monitor them in parallel in pairs. The capacitance of each individual one of these capacitors would be smaller and thus the relative capacitance change, which in general is proportional to the penetration area, that is to say to the destroyed area of the capacitor, would be larger and there would be a clearer signal.

According to the invention, the just described module is made of blanks, which consist of the correspondingly formed planar substrate layer and conductive coatings firmly connected thereto on one or both sides. From these conductive coatings, usually of metal, the desired conducting regions would then be cut out or formed therefrom by selective removal of the conducting material. As a method for removal of the material, etching or milling or else lasering are conceivable, in the case of the latter, in particular by means of a programmable CNC milling machine, either with a fixed milling head, water jet or sand jet, or laser. The specific processing means as such is not part of the present invention, and the person skilled in the art will, depending on the substrate used, as well as the conducting coating material, desired precision and economic points of view, such as the quantity to be produced, from the known processing means, select the one is most suitable for his purposes.

The advantage of this manufacturing process according to the invention is thereby the rapid and simple manufacture of the module according to the invention, since the desired form of the conducting area can be previously determined per software and then cut out of the blank by programmed milling. Here, the blanks may also be selected or cut to size, adapted to available dimensions of the premises to be monitored or the geometry there.

It is thus within the scope of the use according to the invention, during installation, simply to bring the appropriately prefabricated modules to the intended end position and to fix them there on the surface to be monitored, for example by bonding, riveting or screwing, such that they cannot be non-destructively removed from the outside. Since the substrate layer provides the module with stability, in contrast to alarm-wire wall coverings, this can be quickly and easily performed by a small number of fitters with low effort.

It remains to contact/connect the modules according to the invention, by means of wires or directly, to the reference resistors to be measured. The wires here serve either for connection to the corresponding inputs of an alarm system or for connecting together with adjacent or nearby-located surfaces of monitoring modules according to the invention.

For example, the inner surface of a cuboidal room can be monitored completely against penetration by means of 6 of the modules according to the invention, which are adapted to the dimensions of the rooms. Herein, it is advantageously possible, already during the construction phase of the modules, to adapt the contact regions and the profile of the conducting regions such that a connection to the monitoring alarm system is possible with a minimum of wiring effort. If the alarm system is located, for example, in a corner of the room, the contact regions of the modules contiguous to this corner are provided in the vicinity of this corner. The other modules would then be connected in series with those contiguous to the corner, wherein, in an extreme case, all 6 modules can be connected in series. The monitored reference resistor must thus not necessarily be a component external to the alarm system, but could also be integrated therein or at least located in the direct spatial vicinity thereof.

The modules according to the invention and produced by the method according to the invention can be especially easily and favorably produced and used for relatively small and medium-sized volumes, such as, for example, private safes or switch cabinets. Particularly in these small rooms to be monitored, the alarm wire wall coverings known from the prior art are very difficult and complicated to install particularly due to their small size. The grooved panels, which are also known, are easier to install, but very complicated to manufacture. Area monitoring modules formed from a blank by means of CNC milling or by different means according to the present invention are however both inexpensive to manufacture as well as quick and easy to attach on the inner side of the volume to be monitored.

Larger volumes or areas, such as the rooms of a house, bank safe or warehouse hall can, in principle, be very quickly and expediently provided with a passive area monitoring consisting of the modules according to the invention. Although the maximum module size, which can be produced by means of the method according to the invention, are limited by the dimensions and/or the range of the manufacturing means used, a larger area can be easily completely covered by using a plurality of modules. The installation effort here is still much lower compared to the laying of wall coverings and the manufacturing outlay is advantageous compared to the manufacture of grooved panels, so that modules according to the invention manufactured according to the method according to the invention can also be economically employed in these cases.

By means of the method according to the invention, not only planar modules but also those with curvatures can be processed and manufactured in one or even in two directions. This also opens up the possibility of providing, for example, pipes or circular shafts with an area monitoring by means of the modules according to the invention. In such circumstances, in the prior art, the flexibly layable wall coverings could at best be used, wherein even they, if curvatures are present in two directions due to unattractive wrinkling, were firstly difficult to lay and secondly were also not optimally usable in the area coverage of the alarm wires contained therein. If, for example a bending of a circular shaft is to be lined, alarm-wire wall coverings would have to be additionally especially provided with incisions, so that they conform to the double curvature of the surface without the uniform coverage of the surface with alarm wires being compromised. In the case of the modules according to the invention, which are milled from blanks, a correspondingly preformed blank can be provided and conductive regions of the desired form be cut out, the uniform area coverage being readily ensured.

Advantageous further embodiments, which can be implemented individually or in combination, in so far as they are not obviously mutually exclusive, are described below in greater detail.

In the simplest case, the blanks comprising substrate and metallically conductive layer, and thus manufactured by means of the method according to the invention, are flat and planar. The outline may herein be any arbitrary polygonal or else non-polygonal shape, however, a quadrangle, in particular a rectangle, triangle or hexagon, are preferred. Apart from a planar, flat geometry, however, it is also conceivable that the module according to the invention is curved in one or two directions, that is to say for example represents the form of a portion of a cylinder surface or a spherical surface. Also conceivable is a curvature changing across the profile of the module, so that in the general case the module according to the invention forms the geometry of an ellipsoid portion. This permits, by corresponding subdivision of the surface to be monitored, any arbitrary spatial geometry to be equipped with a passive area monitoring by means of modules according to the invention.

Preferably the modules according to the invention for passive area monitoring are designed such that they monitor the surface to be monitored for penetrations by means of resistive, that is to say resistance measurement, and/or capacitive measurement.

To achieve a resistance measurement, in the simplest case, two conductive regions could be formed on opposite surfaces of the non-conducting substrate. On boring with a metal object or tool, a short circuit was caused, which could be registered by the connected alarm system. However, this is unreliable, as this method, in the case of purely resistive monitoring, could not reliably ascertain the penetration by non-conductive objects or tools.

The preferred embodiment in the case of resistance measurement is to provide at least one conductor-path shaped conducting region, which comes close to every point of the substrate area of the module to a predetermined distance. This predetermined distance should be smaller or significantly smaller than the penetration sizes that are to be expected or detected. A conventional design is to run the conductor-path-shaped conducting region in a meandering path over the surface of the module, wherein in the region of a corner or side, one or more contact regions for connecting reference resistances or wires are provided. In the simplest case, the contact regions consist of a simple widening of the conductor path surface, which simplifies a soldering, clamping, screwing or other electrically conductive fixing of the resistances or wires. The contact regions here are preferably congruent with the start or end of the conductor paths to ensure complete monitoring of the surface.

With the exception of a meandering profile, other profiles of the conductor-path-shaped conducting region are conceivable. It would thus be possible, for example, to superimpose a relatively large meander with a smaller one. It is also conceivable, starting from an inner point of the module area to run the conductor path in a spiral shape toward a corner or a point on an edge.

As is also known from the prior art and is specified for systems that are not provided with an individual approval by the VdS, two essentially parallel conductor-path-shaped conducting regions can be provided. Thereof, during operation, one would serve as feed conductor and one as return conductor with respect to the monitoring outputs of the alarm system, and be connected at the other ends of the reference resistor to be monitored.

“Meandering profile” in the context of the present invention does not necessarily mean a continuously rounded profile, but also comprises kinks and corners and in particular a rectangular or sawtooth profile.

To achieve a capacitive area monitoring, the present invention, in the simplest case, proposes providing a substrate layer coated on both sides with conductive material, at least one contact region being present on each conducting region. The two opposite layers here form a surface capacitor with a capacitance proportional to the module surface area. The non-conducting substrate may here advantageously be a dielectric with a highest possible dielectric constant to increase the capacitance of the capacitor. This is in particular advantageous since the capacitance change of the capacitor is proportional to the size of the penetration and is therefore increased correspondingly by the dielectric constant of the substrate. To make the relative capacity change easier to measure, the total surface area of the module can also be subdivided into a plurality of surface capacitors electrically separated from one another, of which each can be separately monitored, that is to say connected in parallel. This would have the additional advantage that, in the case of a penetration with the aid of the affected monitoring lines, that is to say the monitoring lines that register a signal, it is even possible to draw a conclusion about the approximate position of the penetration. In a similar manner, an approximate position location, but also, in the case of resistive area monitoring, is possible if the module area is subdivided into a plurality of regions and each region is covered by a conductor-path-shaped meandering conducting region.

Another embodiment of a capacitive area monitoring consists in providing two or more intermeshing but galvanically separated regions. The capacitance of the capacitors generated in this manner is proportional to the length over which the conducting regions arranged in pairs come close to one another. This in turn is dependent on the total surface area of the module or of the surface area of the region on which the conducting regions are located and the degree of branching of the structure that is chosen. In the simplest case, the present invention proposes designing the conducting regions that come close to one another in pairs as comb-like structures, the combs intermeshing with the teeth. Other geometries, for example fractal structures or root-like branchings are however also conceivable. In order to increase the capacitance per unit area of the generated capacitors, a dielectric could additionally be applied. This could be distributed for example as a paste or in liquid form on the module and subsequently caused to set.

The materials used in the module according to the invention are, for the substrate layer, preferably a plastic, in particular a dielectric plastic, for example polyethylene, polycarbonate, polyvinyl, polyvinyl chloride or polymethyl methacrylate (plexiglas). For the conducting layer of the blank or of the conducting regions, the invention proposes using a metal, in particular aluminum, copper or silver, either pure or as alloy in each case.

The blanks used for manufacturing the module according to the invention are preferably a plastic substrate of the desired geometry, that is two say planar or curved in one or two directions, coated on one or both sides with a conducting, in particular metal layer. Particularly suitable for resistance-based passive area monitoring is a blank with a substrate layer of polyethylene, which is coated on one or both sides with a thermally bonded aluminum layer. Prefabricated modules of this kind with an aluminum layer of a thickness of 0.3 mm or a substrate layer of 1 mm are commercially known under the trade name Alu-Dibond, widely available and inexpensive to purchase.

If such planar modules are processed by the method according to the invention, it has been found that, on removal, in particular milling away of the not-required conducting material of the conducting layer, a deformation of the module may occur, in which the curvature of the module surface changes. In general, this is undesirable. However, this can be effectively countered, on a double-side coated blank, by shaping identical, conducting regions on both sides so that the curvature changes caused by milling act in the same way in both directions and thus essentially cancel each other out. The discussed curvature change can however be desirable and help to adapt the module according to the invention to the geometry of the surface to be monitored.

Further details and features of the present invention are described in greater detail below with reference to the figures of exemplary embodiments. These are only intended to illustrate the present invention and its object, and in no way to limit it.

In detail,

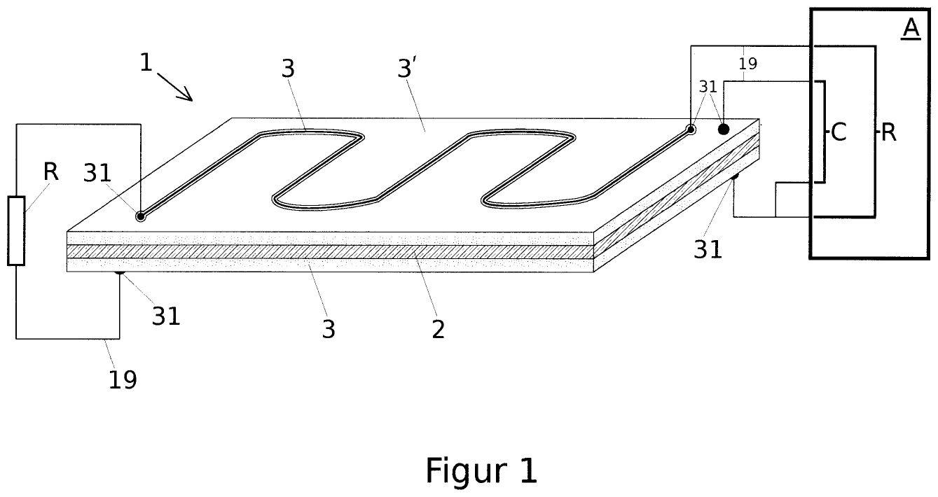

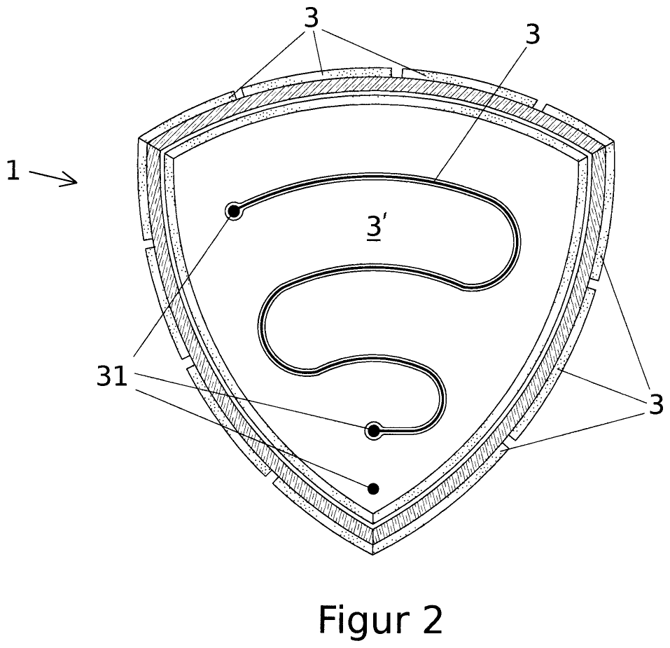

FIG. 1: shows a perspective top view of a planar module according to the invention, which permits both capacitive and resistive area monitoring and is connected to an alarm system.

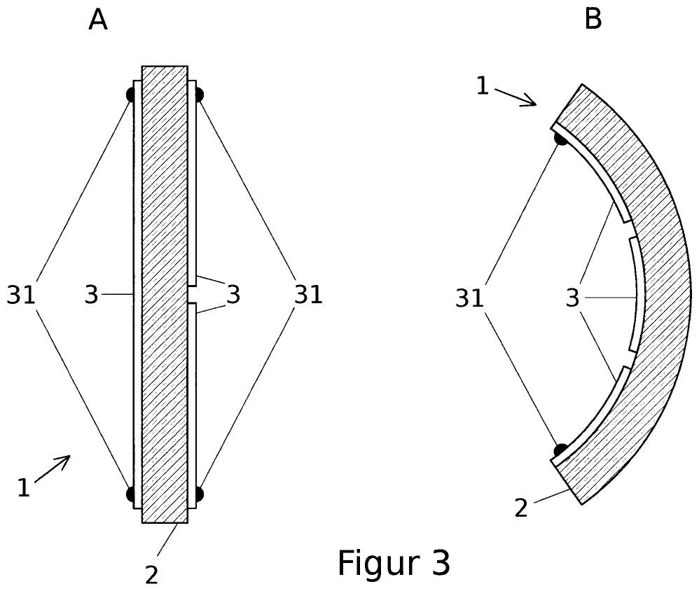

FIG. 2 shows a module curved in two directions according to the invention for surface monitoring.

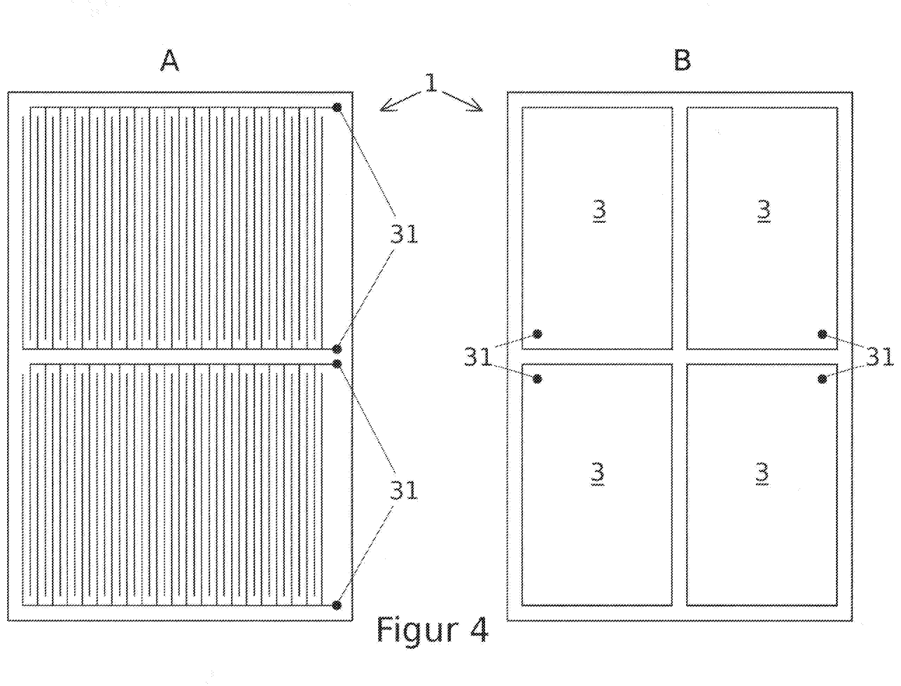

FIG. 3: shows, in two partial figures, cross-sections through a flat and a curved module according to the invention for surface monitoring

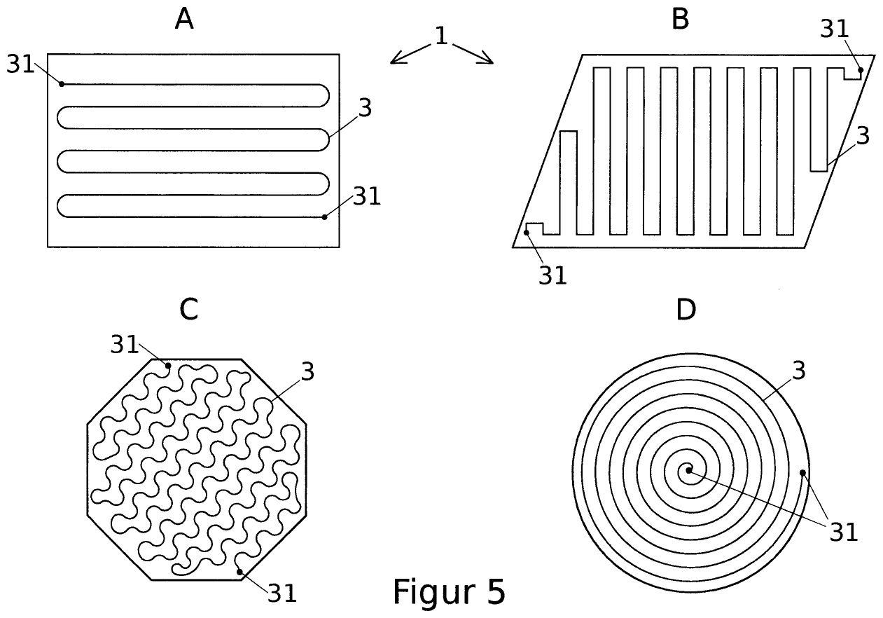

FIG. 4: show, in two partial figures due to a planar and a curved module according to the invention for surface monitoring.

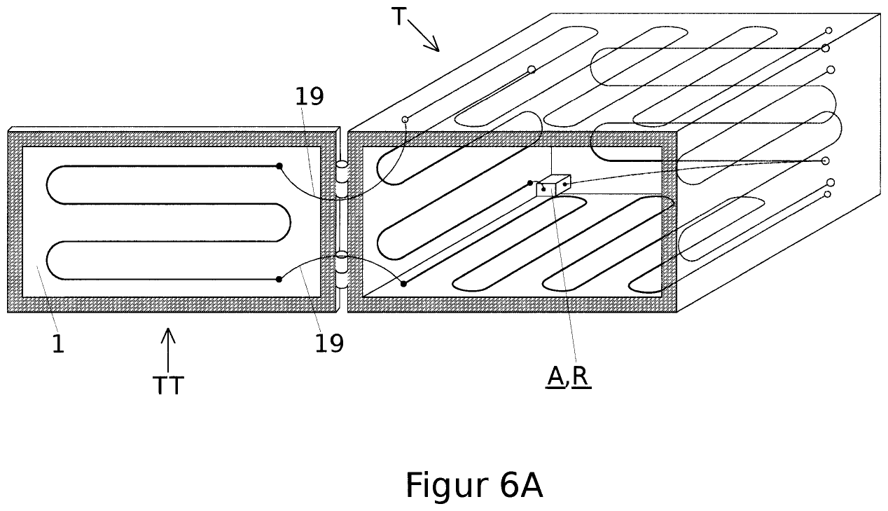

FIG. 5: shows a plurality of possible embodiments of modules according to the invention with conductor-path-shaped conducting regions.

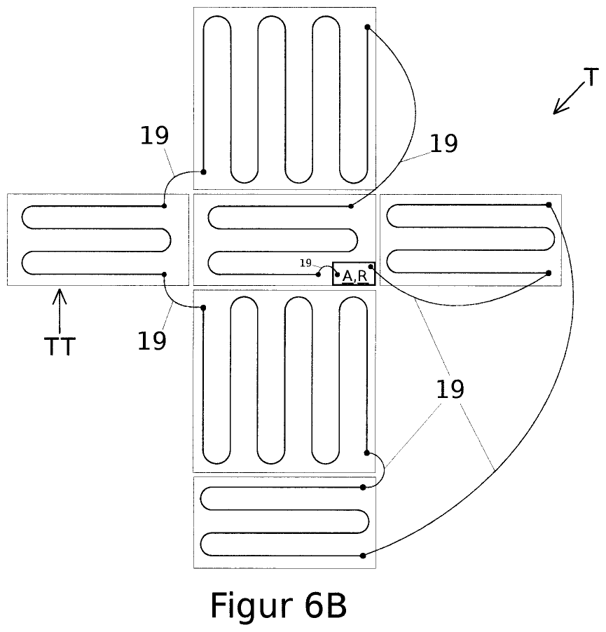

FIG. 6: shows, in two figures, a perspective view of a safe lined with modules according to the invention, as well as the circuitry in cutaway illustration.

FIG. 1 shows in perspective top view a plant module according to the invention for passive surface monitoring. On the top side of the module 1, two conducting regions 3, 3′ with a total of three contact possibilities 31 are located. One of the conducting regions 3, 3′ is designed as a conducting path meandering over the surface, the other conducting region 3′, which is galvanically separate from the first, fills the rest of the module surface. Although this is not technically necessary, two essentially parallel conductor paths, at a small spacing (compared to the size of the module 1), are in each case provided with their own contact means in order to meet VDE regulations. The underside of module 1 is occupied by a conducting region 3 with two contacts 31, which covers the entire surface. Also shown diagrammatically are a reference resistance R, which is connected to the module according to the invention, as well as an alarm system A, which posses inputs C for capacitive and R for resistive area monitoring. The inputs for resistive monitoring are here connected to the conductor-path-shaped region 3 and on the other hand also to the rear conducting region e, which serves as a return conductor. The capacitive monitoring inputs C are connected, on one hand, to the complementary conducting region 3′ on the top side as well as also to the region 3 occupying the entire reverse side. The resistance-based monitoring, in this exemplary embodiment, represents the main function and the capacitive monitoring represents a supplement. The capacitive monitoring, compared to resistive, has a lower sensitivity, however represents a type of additional, partially independent monitoring option, which can also supply a signal, if, against expectation, the meandering conducting region 3 on the top side might not be affected by a possible penetration. To increase the relative significance of the capacitance change caused by a penetration, the complementary conducting region 3′ on the top side could also be subdivided into a plurality of sections to be monitored in parallel, as is shown, for example in FIG. 4b. Of course, the monitoring alarm system would then have to be prepared for or capable of monitoring a plurality of capacitances in parallel.

FIG. 2 shows a perspective view of a module according to the invention for passive area monitoring, which is curved in two directions. Module 1 has herein essentially the geometry of a portion of a spherical surface, which, in a similar way to the module of FIG. 1, has, on the front side, a region 3′ which occupies a meandering, conductive path-shaped conducting region 3 of the surface but is galvanically separated from the first conducting region. On the reverse side of the illustrated module, there are located a plurality of conducting regions 3, which in their entirety cover the reverse side and permit a locally resolved capacitive monitoring. Such curved modules can advantageously be used for monitoring the inner surface of pipes or shafts with a round cross-section with or without bends.

FIG. 3 shows two cross-sections through modules according to the invention. Partial figure A herein shows a cross-section through a planar module in which, on one side of the substrate layer 2, a continuous conducting region 3 with two contacts 31 and on the front side, two regions 3, which are galvanically separate from one another are provided with a contact 31 in each case.

Partial figure B shows curved module 1, wherein conducting regions, a total of three in number with contacts 31, are present on only one side of substrate layer 2.

The thickness of the conducting layer or the conducting regions formed therefrom according to the method according to the invention can in principle be arbitrary in relation to the thickness of the substrate layer 2. However, layer thicknesses that are smaller than the substrate layer are preferred. Particularly preferably, the substrate layer has a thickness of approx. 1 mm and the conducting layer(s) have a thickness of approx. 0.3 mm.

In FIG. 4, two partial figures show possible embodiments of a capacitive area monitoring.

Partial figure A shows in top view a module 1 with two conducting regions 3, which have a comb-like structure, the teeth of the combs intermeshing. By this means, it is achieved that the two conducting regions 3, which are galvanically separate from one another, are close to one another over a widest possible section, so that the capacitance per unit area is maximized. Preferably after milling out of the corresponding comb-like structure, a dielectric is also applied to increase the capacitance area density and caused to set. In addition, a plastic material similar to the substrate material could be used, for example polyethylene, polyvinyl, polycarbonate, polymethyl methacrylate or, particularly preferred, polyvinyl chloride. This would be liquefied, distributed on the surface of the formed module and caused to set by cooling.

Partial figure B shows in top view a module according to the invention, which has a plurality of rectangular shaped conducting regions, in the case, as example, four, which in totality cover the surface of the module 1. The non-visible rear side of this module is subdivided in the same manner or else formed as a single continuous conducting region. The surface capacitors thus formed can be monitored either jointly or separately from one another, wherein the latter option offers the advantage that, from a measured capacitance change, with the aid of the monitored lines on which the capacitance was measured, the approximate position of a penetration can be concluded. The subdivision further has the purpose of increasing the relative capacitance change due to a penetration of a particular area, and in this way making the change easier to measure. A subdivision of the module area into different regions to increase the relative capacitance change of a penetration can also be realized with the principle shown in partial figure A of comb-like capacitors on one module side, in which a plurality of pairs of the intermeshing comb-like conducting regions are cut out.

FIG. 5 shows in top view four possible embodiments of a conductor-path-shaped conducting region 3 in modules 1 for passive area monitoring of different basic area geometry.

Partial figure A shows the meandering region known in the prior art, which loops on a module 1 of rectangular basic area.

Partial figure B shows meandering conductor-path-shaped conducting regions 3, which are not continually rounded but extend in a rectangular manner over a module 1 with trapezoidal basic surface.

Partial figure C shows a double meander, in which the loops with larger radius of curvature are superimposed by loops with a smaller radius of curvature. These double meanders extend over a hexagonal module 1.

Partial figure D shows a conductor-path-shaped conducting region 3, which, starting from an inner contact region 31, co-extends in a spiral manner over the surface of an elliptical module 1 as far as a further contact point 31 at the edge.

FIG. 6 shows, in partial figure A, in perspective view, a use of six planar and rectangular modules 1 according to the invention for area monitoring of a safe T.

The modules are all connected in series by means of conducting connections 19, in particular wires, and bonded to alarm system A, which is visible, located in a rear corner, through the open door of the safe T. The monitored reference resistor R is herein part of the alarm system A.

Partial figure B shows schematically the circuit of the modules 1 of the six sides of the safe. The series connection here must take into account the fact that the side of the door TT can only be contacted from one edge, so that preferably all contact points of the module covering door TT are located in the vicinity of the pivoting side of the door.

### LIST OF REFERENCE CHARACTERS

1 Module
19 Conducting connection, wire
2 Substrate layer
3, 3′ Conducting regions
31 Contact points
A Alarm system
C Inputs for capacitive monitoring
R Inputs for resistive monitoring
T Safe
TT Door

1. A module for the passive monitoring of areas for penetration in interaction with an alarm system, comprising:
a non-conducting, mechanically stable substrate layer, and
at least two conducting regions, which are superimposed on the substrate layer and are connected thereto, and of which the extent is significantly smaller in at least one spatial direction than in the other,
wherein at least two of the conducting regions have contacts, by means of which they can be contacted via wires and in particular can be connected to the alarm system.

2. The module according to claim 1, wherein:
it forms a planar or curved surface, and/or
the penetration monitoring is performed by means of the conducting regions, by means of capacitance or resistance measurement.

3. The module according to claim 1, wherein at least one of the conducting regions is formed as a conductor path, which comes close to every point of the substrate layer at least up to a predetermined distance.

4. The module according to claim 3, wherein the conductor-path-shaped conducting region has two contacts and the penetration measurement is performed by means of resistance measurement.

5. The module according to claim 1, wherein:
at least two conducting regions, which are designed as a conductor path, are present, and/or
two regions, which are designed as conductor paths are present, which run essentially in parallel, and/or
the conductor path-shaped conducting regions run in a meandering and/or spiral path on the substrate layer.

6. The module according to claim 1, wherein the at least two conducting regions are designed such that they are planar and have in each cast at least one contact.

7. The module according to claim 1, wherein the at least two conducting regions are planar and lie on opposite sides of the module.

8. The module according to claim 1, wherein:
the substrate layer is made of a dielectric and/or a plastic material, in particular polyethylene, polycarbonate, polyvinyl, polyvinyl fluoride or polymethyl methacrylate, and/or
the conductive regions are made of a metal, in particular aluminum, copper or silver.

9. A method for manufacturing a module for the passive monitoring of areas for penetration in interaction with an alarm system, comprising the steps:
preparing a blank, in particular a planar or curved, two- or three-layer panel, comprising a substrate layer which is covered on one or both sides with a conducting, in particular metal material, and
selectively removing the conducting material, in particular by mechanical milling, lasering and/or etching, such that desired conducting regions with contact points are formed therefrom.

10. The method according to claim 9, wherein the blank is coated on both sides with the conducting material, and congruent conducting regions are formed on both sides.

11. A method of using a module manufactured according to the method of claim 9, comprising the steps:
making contact with the contact points by means of wires, in particular by soldering, clamping, screw connecting or bonding, and
connecting the wires to a reference resistor and/or an alarm system.
